(19) United States
(12) Patent Application Publication
(10) Pub. No.: US 2006/0198487 A1
(43) Pub. Date: Sep. 7, 2006

(54) Fusionable material target

(75) Inventor: Michel Georges Laberge, Bowen Island (CA)

Correspondence Address: KOLISCH HARTWELL, P.C., 200 PACIFIC BUILDING, 520 SW YAMHILL STREET, PORTLAND, OR, 97204, US

(73) Assignee: General Fusion Inc.

(21) Appl. No.: 11/073,423

(22) Filed: Mar. 4, 2005

(51) Int. Cl. H05H 6/00

(52) U.S. Cl. 376/151

(57) ABSTRACT

A fusionable material target apparatus for use in a fusion reactor having fusion reactions initiated by a pressure wave in a heated liquid medium is disclosed. The apparatus includes a container for enclosing fusionable material, the container being operable to be cooled until at least some of the fusionable material is in a solidified state. The container operable to be received in the heated liquid medium. The apparatus also includes a heat insulator for insulating the container while the container is in the heated liquid medium for a time sufficient to maintain at least some of the fusionable material in the solidified state until fusion is initiated by the pressure wave.

This application is related to the US patent application entitled “Pressure Wave Generator and Controller for Generating a Pressure Wave in a Fusion Reactor” by Laberge et al. filed concurrently herewith and incorporated herein by reference.

### BACKGROUND OF THE INVENTION

1. Field of Invention

This invention relates to fusionable material targets for use in fusion reactors.

2. Description of Related Art

Nuclear fusion reactions involve bringing together atomic nuclei against their mutual electrostatic repulsion and fusing them together to make heavier nuclei, while at the same time releasing energy. Isotopes of light elements (i.e. elements having a relatively small number of protons) are the easiest to fuse, because the electrostatic repulsion between the nuclei of light elements is smaller than that of heavier elements. The use of light elements may produce significantly reduced collateral radioactivity than comparable fission reactors, which typically use isotopes of heavier elements.

Inducing nuclear fusion reactions is difficult, because of the energies required to accelerate the nuclei to speeds fast enough to overcome their mutual electrostatic repulsion and because the nuclei are so small that the chance that two passing nuclei will interact with one another in a manner which results in fusion of the nuclei is small.

Fusion reactors typically require input energy to initiate fusion reactions. The amount of input energy required is largely determined by the need to accelerate the nuclear reactants to thermonuclear speed and to confine the nuclear reactants in a space that allows them to interact. A reactor that consumes less energy than it produces is said to produce net energy. Such a reactor will have an efficiency ratio (the ratio of energy output to the energy input) greater that unity. The energy output of a fusion reactor is largely determined by the number of fusion reactions that are induced in the reactor and the amount of energy that is released and captured.

There remains a need for methods and apparatus that facilitate improvements to the efficiency of nuclear fusion reactors.

### SUMMARY OF THE INVENTION

In accordance with one aspect of the invention there is provided in a fusion reactor having fusion reactions initiated by a pressure wave in a heated liquid medium, a method for confining a fusionable material in a fusionable material target. The method involves enclosing fusionable material in a container operable to be cooled until at least some of the fusionable material is in a solidified state. The container is operable to be received in the heated liquid medium. The method also involves heat insulating the container while the container is in the heated liquid medium for a time sufficient to maintain at least some of the fusionable material in the solidified state until fusion is initiated by the pressure wave.

Enclosing fusionable material in the container comprises enclosing fusionable material in a glass micro-balloon.

Enclosing fusionable material in the container may involve diffusing fusionable material into the container.

Insulating the container may involve enclosing the container in a metal shell.

Enclosing the container in the metal shell may involve enclosing the container in a lead and lithium shell.

The method may involve grading a density of the metal shell such that the density increases from an inner surface of the shell to an outer surface of the shell.

Enclosing fusionable material in a container may involve enclosing fusionable material in a first container and may further involve enclosing the first container in a second container and evacuating a space between the first container and the second container.

The method may involve holding the first container in the second container.

The method may involve forming a reflective coating on an outside surface of the first container.

In accordance with another aspect of the invention there is provided a fusionable material target apparatus for use in a fusion reactor having fusion reactions initiated by a pressure wave in a heated liquid medium. The apparatus includes provisions for enclosing fusionable material in a container operable to be cooled until at least some of the fusionable material is in a solidified state, the container operable to be received in the heated liquid medium. The apparatus also includes provisions for heat insulating the container while the container is in the heated liquid medium for a time sufficient to maintain at least some of the fusionable material in the solidified state until fusion is initiated by the pressure wave.

In accordance with another aspect of the invention there is provided a fusionable material target apparatus for use in a fusion reactor having fusion reactions initiated by a pressure wave in a heated liquid medium. The apparatus includes a container for enclosing fusionable material, the container being operable to be cooled until at least some of the fusionable material is in a solidified state. The container operable to be received in the heated liquid medium. The apparatus also includes a heat insulator for insulating the container while the container is in the heated liquid medium for a time sufficient to maintain at least some of the fusionable material in the solidified state until fusion is initiated by the pressure wave.

The container may include a glass micro-balloon.

The container may include a metal shell.

The metal shell may include a lead and lithium shell.

The insulator may include a metal shell having a graded density such that the density increases from an inner surface of the metal shell to an outer surface of the metal shell.

The container may include a first container and the heat insulator may include a second container. The second container may be operably configured to enclose the first container such that a space is formed between the first container and the second container, the space being evacuated.

The apparatus may include a pair of wires for holding the first container in the second container.

The apparatus may include a reflective coating formed on an outside surface of the first container.

In accordance with another aspect of the invention there is provided a fusionable material target apparatus for use in a fusion reactor comprising a container for enclosing fusionable material, the container having a wall formed of lithium salt.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a cross sectional view of a fusion reactor according to a first embodiment of the invention;

FIGS. 2 & 3 are cross sectional views of one embodiment of a fusionable material target for use in the reactor shown in FIG. 1;

FIGS. 4 & 5 are cross sectional views illustrating a method of fabricating the fusionable material target shown in FIG. 2;

FIG. 6 is a cross sectional view of another embodiment of a fusionable material target for use in the reactor shown in FIG. 1;

FIG. 7 is a cross sectional view of yet another embodiment of a fusionable material target for use in the reactor shown in FIG. 1; and

FIG. 8 is a cross sectional view of yet another embodiment of a fusionable material target for use in the reactor shown in FIG. 1.

### DETAILED DESCRIPTION

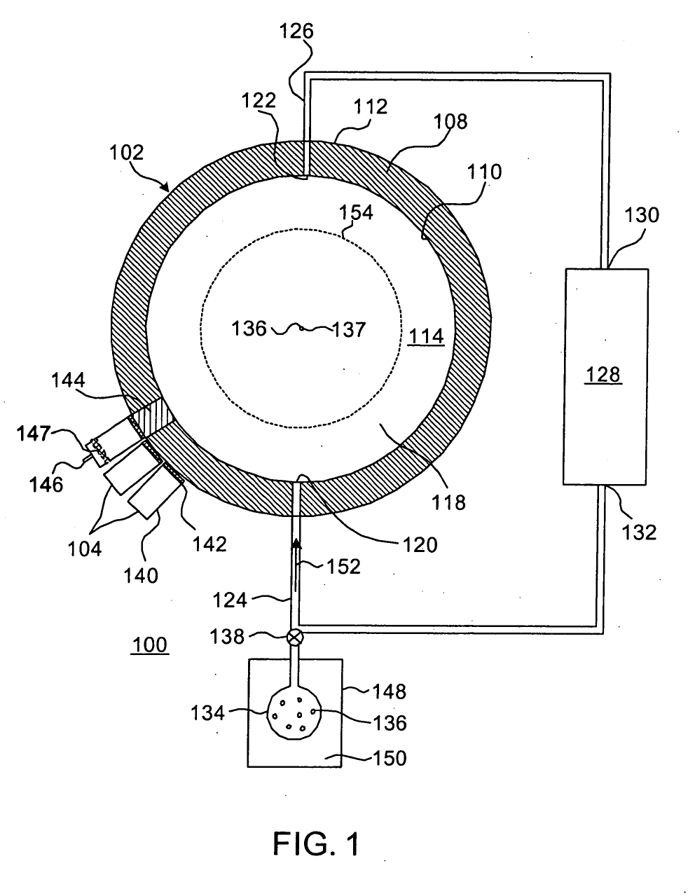

Referring to FIG. 1, a fusion reactor according to a first embodiment of the invention is shown generally at 100. The fusion reactor 100 includes a vessel 102 and a plurality of pressure wave generators 104 located on the outside of the vessel. The vessel 102 includes a wall 108, which has an inside surface 110 and an outside surface 112. The inside surface 110 of the wall 108 defines an inner cavity 114, which contains a liquid medium 118. The liquid medium 118 may be a molten metal, such as lead, lithium, sodium, or a mixture of such metals. The liquid medium 118 may also contain additives that enhance the properties thereof, for example by enhancing neutron shielding or increasing the density of the liquid medium.

The wall 108 of the fusion reactor 100 further includes an inlet aperture 120 and an outlet aperture 122 disposed on diametrically opposite sides of the reactor. The fusion reactor 100 also includes an inlet conduit 124 in communication with the inlet aperture 120 and an outlet conduit 126 in communication with the outlet aperture 122. The fusion reactor 100 further includes a recirculation system 128, which includes an input 130 in communication with the outlet conduit 126 and an output 132 in communication with the inlet conduit 124. The recirculation system 128 also includes a pump (not shown) for circulating the liquid medium 118 through the fusion reactor 100 and may also include facilities for maintaining the liquid medium at a desired temperature by adding or extracting heat energy from the liquid medium. The recirculation system 128 may also include a turbine (not shown) for converting heat energy into electrical energy.

The pressure wave generators 104 are located on the outside surface 112 of the wall 108 (only some of the pressure wave generators are shown for clarity). Each pressure wave generator 104 includes a housing 140 and a piston 142, which is moveable in the housing and capable of impacting the outside surface 112 of the wall 108 to cause a pressure wave to be generated in the liquid medium 118. Each pressure wave generator 104 further includes a fluid port 146, in communication with a source of pressurised fluid (not shown), for applying a fluid pressure to the housing 140 to actuate the piston 142. Each pressure wave generator 104 may be independently controllable, allowing respective pistons to impact the outside surface 112 of the wall 108 at a desired time and with a desired amount of kinetic energy. The kinetic energy due to the piston impact causes a compression wave in the wall 108 which travels through the wall and into the liquid medium 118, thus generating a pressure wave in the liquid medium. In some embodiments the wall 108 may include a moveable transducer 144 in the wall 108 (only one moveable transducer is shown in FIG. 1). The moveable transducer 144 is coupled to the liquid medium 118 and operates by receiving kinetic energy from the piston 142 and converting the kinetic energy into a pressure wave in the liquid medium 118. A suitable pressure wave generator and transducer is described in the related patent application entitled “Pressure Wave Generator and Controller For Generating a Pressure Wave in a Fusion Reactor” by Laberge et al.

The fusion reactor 100 also includes a reservoir 134, in communication with the inlet conduit 124 through a valve 138. The reservoir 134 holds fusionable material targets 136 and, in combination with the valve 138, facilitates the introduction of the fusionable material targets 136 into the liquid medium 118 through the inlet conduit 124. The fusionable material target 136 may include fusionable material in a gaseous form and may include an isotope of a light element, such as deuterium, tritium, 3He, or a combination thereof. The fusion reactor 100 also includes a Dewar 148 for containing a liquefied gas 150. The Dewar 148 encloses the reservoir 134, facilitating cooling of the fusionable material targets 136 by liquefied gasses, such as Helium or Nitrogen, to very low temperatures.

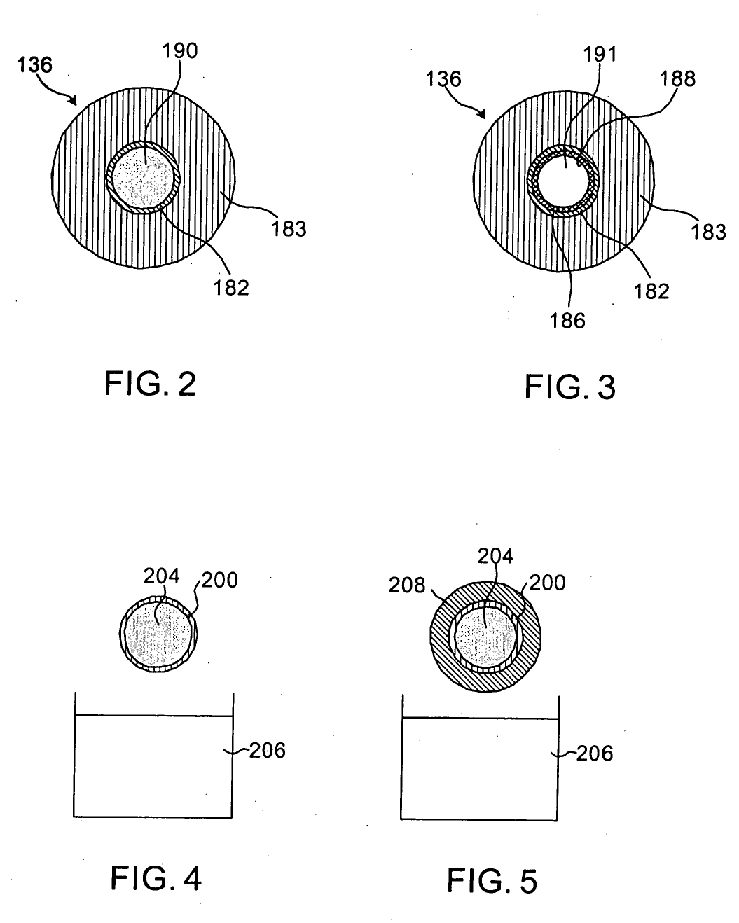

The fusionable material target 136 is shown in greater detail in FIG. 2. The fusionable material target 136 includes a container 182 and a heat insulating metal 183 enclosing the container. The heat insulating metal 183 may be a mixture of 17% lithium and 83% lead by volume. The container 182 has an inner surface 188 and encloses a gaseous fusionable material 190. The container 182 may be a glass micro-balloon. Glass micro-balloons filled with fusionable materials such as deuterium-tritium (D-T) have been supplied to various fusion reactor projects by General Atomic of San Diego, Calif. Such micro-balloons are capable of holding fusionable materials such as deuterium at high and ultra high pressure. Micro-balloons may be fabricated in a drop tower furnace and the fusionable material may be diffused into the micro-balloons by placing the micro-balloons in a high pressure atmosphere of gaseous fusionable material. Alternatively, the micro-balloon may be fabricated form a material other than glass, such as a plastic.

The operation of the fusionable material target 136 is described with reference to FIG. 1 and FIG. 3. The fusionable material target 136 is cooled to a temperature below the freezing point of the gaseous fusionable material 190 by the liquefied gas 150 in the Dewar 148, thus forming a solidified fusionable material layer 186 on the inner surface 188 of the container 182. A small quantity of gaseous fusionable material 191 remains in a gaseous state at vapour pressure equilibrium with the solidified fusionable material layer 186.

The valve 138 is then activated to allow one of the fusionable material targets 136 to be introduced into the inlet conduit 124 from the reservoir 134. The recirculation system 128 causes a flow of the liquid medium 118 into the inner cavity 114 in a direction shown by arrow 152. The fusionable material target 136 is carried upwardly into the inner cavity 114 by the buoyancy of the target and the flow in the direction 152. When the fusionable material target 136 reaches a point in the inner cavity 114 that is proximate a center 137 of the inner cavity, a pressure wave is initiated in the liquid medium 118. Since the upwards movement of the fusionable material target 136 continues while the pressure wave propagates through the liquid medium 118, the activation of the pistons 142 is timed such that the pressure wave converges to the location of the target when the target reaches the center 137 of the inner cavity 114. A suitable controller for timing the initiation of the pressure wave is described in the related application “Pressure Wave Generator and Controller for Generating a Pressure Wave in a Fusion Reactor” by Laberge et al.

The liquid medium 118 may include a mixture of molten metals such as lead or lithium and the temperature of the liquid medium may be 400 degrees Celsius or greater. When the fusionable material target 136 is introduced into the liquid medium 118, the heat insulating metal 183 will begin to melt. However, the composition and thickness of insulating metal 183 is selected such that the solidified fusionable material layer 186 remains at least partially frozen while the fusionable material target 136 moves towards the center 137 of the inner cavity 114. Consequently, the container 182 is at least partially insulated from the hot liquid medium 118 by the insulating metal 183, thus facilitating introduction of the target into the fusion reactor such that at least a portion of the solidified fusionable material layer 186 will remain frozen.

As previously described, the pressure wave is initiated such that it converges on the fusionable material target 136 when the target reaches the center 137 of the inner cavity 114. The pressure wave has a pressure wavefront 154 that envelopes and converges on the fusionable material target 136. Referring to FIGS. 1 and 3, when the pressure wavefront 154 reaches the fusionable material target 136, the energy in the pressure wave adiabatically compresses the remaining insulating metal 183 and the container 182. The energy in the pressure wave is converted into heat energy, which is concentrated on the gaseous fusionable material 191.

The gaseous fusionable material 191 heats up much quicker than the solidified fusionable material layer 186 and thus fusion reactions will be initiated in the gaseous fusionable material before the solidified fusionable material layer completely melts. The fusion reaction in the gaseous fusionable material 190 generates neutrons and alpha particles. For a fusionable material of deuterium-tritium (D-T), approximately 20% of the fusion energy will be released in the form of fast alpha particles. These alpha particles have a very short range and will therefore deposit a substantial portion of their energy in the solidified fusionable material layer 186, thus heating up this layer. This heating in turn initiates further fusion reactions which generate further alpha particles thus causing a detonation front to propagate in the fusionable material target 136.

In contrast, for a fusionable material target that has all the fusionable material in the gaseous form, it is necessary to heat and compress a larger amount of fusionable material all at once. Additional energy is required to confine the fusionable materials while heating the materials to fusion temperatures. Thus for a purely gaseous fusionable material, additional energy is required in the pressure wave to both heat and confine the fusionable materials. Advantageously, the fusionable material target 136 requires less input energy in the form of a pressure wave to initiate fusion reactions since the pressure wave energy is initially concentrated on the gaseous fusionable material 191, which is a smaller quantity than the solidified fusionable material layer of fusionable materials.

A method for fabricating the fusionable material target 136 is described with reference to FIG. 4 and FIG. 5. Referring to FIG. 4, a glass micro-balloon 200 contains a gaseous fusionable material 204. The micro-balloon is subjected to a low temperature, although not necessarily below the freezing point of the fusionable materials contained therein. The micro-balloon 200 is then dipped in a bath of molten lead and lithium 206 and then removed again.

Referring to FIG. 5, a layer of lead-lithium 208 solidifies on an outside surface of the micro-balloon 200. The micro-balloon 200 is again cooled and dipped in the bath of molten lead and lithium 206. The process is repeated, each time encasing the lead-lithium in an additional layer of solidified lead lithium, until a sufficiently thick layer of lead-lithium 208 is formed, such that the fusionable materials will be insulated from the hot liquid medium 118 when the frozen fusionable material target 136 is introduced into the fusion reactor 100.

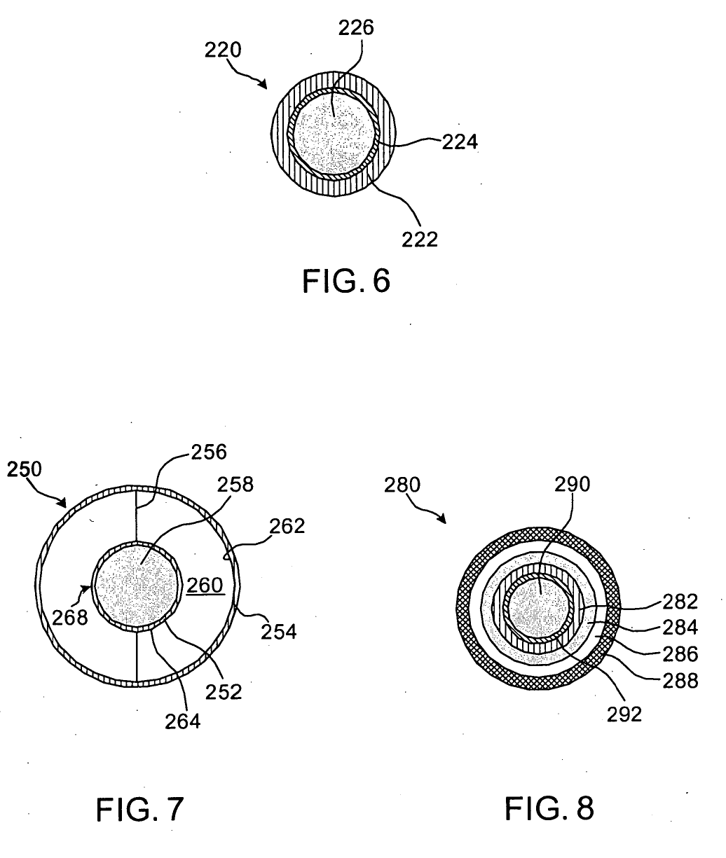

Referring to FIG. 6, an alternative embodiment of a fusionable material target is shown at 220. The fusionable material target includes a lithium salt container 222 (lithium-duteride and lithium-triteride (LiT and LiD)) which encloses a gaseous fusionable material 226. The lithium salt container 222 may also be frozen thus forming a solidified fusionable material layer 226 on an inside surface of the lithium salt container. The lithium salt container 222 has a higher melting point than a lead-lithium liquid medium and thus acts both as an enclosing container for the fusionable material and as an insulator from the hot liquid medium, thus facilitating introduction of the fusionable material target 220 into a hot liquid medium 118. Advantageously, the deuterium and tritium in the lithium salt may also participate in the fusion reaction, further improving the fusion yield.

Referring to FIG. 7 another alternative embodiment of a fusionable material target is shown at 250. The fusionable material target 250 includes a first container 252 and a second container 254. The second container 254 completely encloses the first container 252 and there is an evacuated space 260 between the first container and the second container. The first container 252 contains a quantity of gaseous fusionable material 258 (which may be partly frozen before being introduced in a fusion reactor). The first container 252 is also held inside the second container 254 by a pair of wires 256, attached between an inside surface 262 of the second container and an outside surface 264 of the first container. The outside surface 264 of the first micro-balloon may also be coated with a reflective layer 268. The reflective layer 268 may be a coating of gold.

As described above in relation to other embodiments, the fusionable material target may be cooled such that at least a portion of the gaseous fusionable material 258 solidifies. The evacuated space 260 operates as a very good insulator of heat. When the target is to be introduced into a fusion reactor having a hot liquid medium 118, the evacuated space 260 and the reflective layer 268 insulate the fusionable material, such that the frozen fusionable materials remain at least partially frozen. The use of the reflective layer 268 further improves the insulation by reflecting energy having infrared wavelengths, thus further insulating the solidified fusionable material layer 258.

Referring to FIG. 8, another alternative embodiment of a fusionable material target is shown at 280. The fusionable material target 280 is similar to the target shown in FIG. 2 and includes a container 292 for containing a fusionable material 290. However, in this embodiment, the fusionable material target 280 includes a plurality of metal insulating layers 282-288. The plurality of insulating layers 282-288 have successively increasing density, the innermost insulating layer 282 having the lowest density and the outermost insulating layer 288, having the highest density. The outermost insulating layer 288 has a density and composition that is approximately matched to the density and composition of the liquid medium 118. The approximate matching of density between the liquid medium 118 and the fusionable material target 280 facilitates coupling of the pressure wave into the fusionable material target 280 without a significant reflection of pressure wave energy. For example, in one embodiment the liquid medium may be a mixture of lead and lithium, with a lithium concentration of 17%. The plurality of plurality of metal insulating layers 282-288 may also be a mixture of lead and lithium with the outermost layer 288 having 20% lithium concentration, the layer 286 having 50% lithium concentration, the layer 284 having 75% lithium concentration and the innermost layer 282 having almost 100% lithium concentration. A pressure wave coupling into the fusionable material target 280 will progressively accelerate as it propagates through the successively less dense layers. Advantageously energy in the accelerated pressure wave is more quickly converted into heat energy in the fusionable material, preventing loss of heat during the initiation of the fusion reactions therein.

While specific embodiments of the invention have been described and illustrated, such embodiments should be considered illustrative of the invention only and not as limiting the invention as construed in accordance with the accompanying claims.

1. In a fusion reactor having fusion reactions initiated by a pressure wave in a heated liquid medium, a method for confining a fusionable material in a fusionable material target, the method comprising:
enclosing fusionable material in a container operable to be cooled until at least some of the fusionable material is in a solidified state, said container operable to be received in the heated liquid medium; and
heat insulating said container while said container is in the heated liquid medium for a time sufficient to maintain at least some of said fusionable material in said solidified state until fusion is initiated by the pressure wave.

2. The method of claim 1 wherein enclosing fusionable material in said container comprises enclosing fusionable material in a glass micro-balloon.

3. The method of claim 1 wherein enclosing fusionable material in said container comprises diffusing fusionable material into said container.

4. The method of claim 1 wherein insulating said container comprises enclosing said container in a metal shell.

5. The method of claim 4 wherein enclosing said container in said metal shell comprises enclosing said container in a lead and lithium shell.

6. The method of claim 4 further comprising grading a density of said metal shell such that said density increases from an inner surface of said shell to an outer surface of said shell.

7. The method of claim 1 wherein enclosing fusionable material in a container comprises enclosing fusionable material in a first container and further comprising enclosing said first container in a second container and evacuating a space between said first container and said second container.

8. The method of claim 7 further comprising holding said first container in said second container.

9. The method of claim 7 further comprising forming a reflective coating on an outside surface of said first container.

10. A fusionable material target apparatus for use in a fusion reactor having fusion reactions initiated by a pressure wave in a heated liquid medium, the apparatus comprising:
means for enclosing fusionable material in a container operable to be cooled until at least some of the fusionable material is in a solidified state, said container operable to be received in the heated liquid medium; and
means for heat insulating said container while said container is in the heated liquid medium for a time sufficient to maintain at least some of said fusionable material in said solidified state until fusion is initiated by the pressure wave.

11. A fusionable material target apparatus for use in a fusion reactor having fusion reactions initiated by a pressure wave in a heated liquid medium, the apparatus comprising:
a container for enclosing fusionable material, said container being operable to be cooled until at least some of the fusionable material is in a solidified state, said container operable to be received in the heated liquid medium; and
a heat insulator for insulating said container while said container is in the heated liquid medium for a time sufficient to maintain at least some of said fusionable material in said solidified state until fusion is initiated by the pressure wave.

12. The apparatus of claim 11 wherein said container comprises a glass micro-balloon.

13. The apparatus of claim 11 wherein said container comprises a metal shell.

14. The apparatus of claim 13 wherein said metal shell comprises a lead and lithium shell.

15. The apparatus of claim 13 wherein said insulator comprises a metal shell having a graded density such that said density increases from an inner surface of said metal shell to an outer surface of said metal shell.

16. The apparatus of claim 11 wherein said container comprises a first container and said heat insulator comprises a second container, said second container operably configured to enclose said first container such that a space is formed between said first container and said second container, said space being evacuated.

17. The apparatus of claim 16 further comprising a pair of wires for holding said first container in said second container.

18. The apparatus of claim 16 further comprising a reflective coating formed on an outside surface of said first container.

19. A fusionable material target apparatus for use in a fusion reactor the apparatus comprising a container for enclosing fusionable material, said container having a wall formed of lithium salt.
